(19) United States
(12) Patent Application Publication
(10) Pub. No.: US 2003/0225620 A1
(43) Pub. Date: Dec. 4, 2003

(54) Method and system for placing offers using randomization

(75) Inventors: Lance Nelson, Clyde Hill, WA (US); Ryan Penner, Bellevue, WA (US); Michael Ramirez, Seattle, WA (US); Brett Melton, Bothell, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Aptimus, Inc.

(21) Appl. No.: 10/390,570

(22) Filed: Mar. 13, 2003

Related U.S. Application Data
(60) Provisional application No. 60/363,939, filed on Mar. 13, 2002.

(51) Int. Cl. G06F 17/60

(52) U.S. Cl. 705/14

(57) ABSTRACT

The present invention provides a system where offers are placed on network accessible sites or delivered to consumers over a network. Placement data is used to obtain offers that share at least one category with placements of offers for consumers. Each offer has a placement value for placement. The offers are randomized by forming randomized placement values for the placement. These randomized placement values are calculated by adding a random factor ranging up to at least the value of the highest placement value to each of the offers' placement values. The offer with the highest randomized placement value is then placed for viewing, or receipt, by the consumer.

### CROSS-REFERENCE TO RELATED APPLICATION

This application claims the benefit of U.S. Provisional Patent Application Serial No. 60/363,939, filed on Mar. 13, 2002, which is hereby incorporated by reference.

### FIELD OF THE INVENTION

The present invention relates in general to online communications and in particular to a system and method for automating the placement of online offers for consumers.

### BACKGROUND OF THE INVENTION

Communication networks are well known in the computer communications field. By definition, a network is a group of computers and associated devices that are connected by communications facilities or links. An internetwork, in turn, is the joining of multiple computer networks, both similar and dissimilar, by means of gateways or routers, that facilitate data transfer and conversion from various networks. A well-known abbreviation for the term internetwork is “internet.” As currently understood, the capitalized term “Internet” refers to the collection of networks and routers that use the Internet Protocol (“IP”), to communicate with one another. The Internet has recently seen explosive growth by virtue of its ability to link computers located throughout the world. One form of such linking is a hypertext Web of interlinked hypertext “pages” know as the World Wide Web (“Web”). As will be appreciated from the following description, the present invention could find use in many interactive environments; however, for purposes of discussion, the Internet and the Web are used as an exemplary interactive environment for implementing the present invention.

The Internet has quickly become a popular method of disseminating information due in large part to its ability to deliver information quickly and reliably. To send a document or other data over the Internet, businesses often present information on Web pages. Additionally, other forms of more direct communication may address consumers using communications software, such as e-mail programs, to send information to consumers via their e-mail addresses.

Web pages for businesses have progressed along with the development of the Internet. In particular, the placement of offers or advertisements on Web pages to attract the attention of consumers has become a source of revenue on the Internet. The placement of these offers (search results, advertisements, banners, “pop-ups”, “pop-unders” and other electronic offer messages) generally involves some payment for the exposure and/or effectiveness of the displayed offers. However, the selection of offers shown has been either random, or purely deterministic leaving consumers exposed to random (often irrelevant) ads or repeatedly seeing the same (desensitizing) ads. An additional drawback is that previous systems required involved administrator intervention to provide variety among the set routine of deterministic ad rotations. Still further intervention was required to target ads to particular consumers or groups of consumers. These administratively intensive systems failed to provide an optimized method of placing offers that still allows for indeterministic placements of offers for consumers.

The use of e-mail for advertising has also progressed along with the development of the Internet. While at an individual-to-individual level, the sending of e-mail is an effective communication method, the sending of large quantities of placed offer e-mails to a multitude of different consumers has been a slow and inefficient process. Such previous systems have required operator intervention to place appropriate offers for consumers, or have used static matching that did not automatically adjust to optimize placements.

Accordingly, there is a need for a method of automatically controlling the placement of offers for consumers and that optimizes offer placements in an automated manner.

### SUMMARY OF THE INVENTION

In accordance with one aspect of the current invention, offers are placed on a network accessible site (such as a Web site or other online site). More specifically, placement data for the network site is obtained from a server of the network site. This placement data is used to extract placement information and to obtain offers that share at least some information category with the placement information from the placement data. Each offer has a placement value associate with the placement at the placement site. Rather than placing an offer based simply on it placement value, the placement values are randomized by varying the placement value for offer by a random factor. The offer with the highest randomized placement value is then placed in a placement slot on the network accessible site. If the network site has more than one slot, the offer with the highest placement values are ranked to fill the slots.

In yet another embodiment of the present invention, an offer is delivered to a consumer over a network by first obtaining a plurality of offers with information that matched some consumer information. Then a weighted offer value is calculated for each of the offers. This, in turn, is used to calculate randomized weighted offer values by varying each offer's weighted offer value by a random factor. The offer with the highest randomized weighted offer value is then sent to the consumer.

In accordance with yet further aspects of the present invention, weighted offer values are determined by use of a formula that considers the consumer response given to the offers. For example, consumer response may be measured by how many times offer messages are opened per total offer messages, how many offers are “clicked” on per total offer messages, how many orders are placed through offer messages, or whether a particular offer relates to another offer, so as to boost its placement value.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a pictorial diagram of a number of devices connected to a network which coordinate to place offers for depiction at consumer devices in accordance with the present invention.

FIG. 2 is a block diagram of a offer server that includes a memory.

FIG. 3 is a diagram illustrating the actions taken by a consumer device, Web server, offer server, and database server to place offers in accordance with the present invention.

FIG. 4 is an overview flow diagram illustrating a routine for Web offer selections formed in accordance with the present invention.

FIG. 5 is a diagram illustrating the actions taken by an offer server, database server, e-mail server, and consumer device to place offers in accordance with the present invention.

FIG. 6 is an overview flow diagram illustrating an e-mail offer selection routine formed in accordance with the present invention.

FIG. 7 is an overview flow diagram illustrating a consumer response summarization routine formed in accordance with the present invention.

FIG. 8 is a table of exemplary offer placement slots and potential offers used as an example of an embodiment of the present invention.

FIG. 9A shows an exemplary table with consumer response information to e-mailed offers usable by an exemplary embodiment of the present invention.

FIG. 9B shows a table of exemplary offers and their categories and placement values formed in accordance with an exemplary embodiment of the present invention.

### DETAILED DESCRIPTION

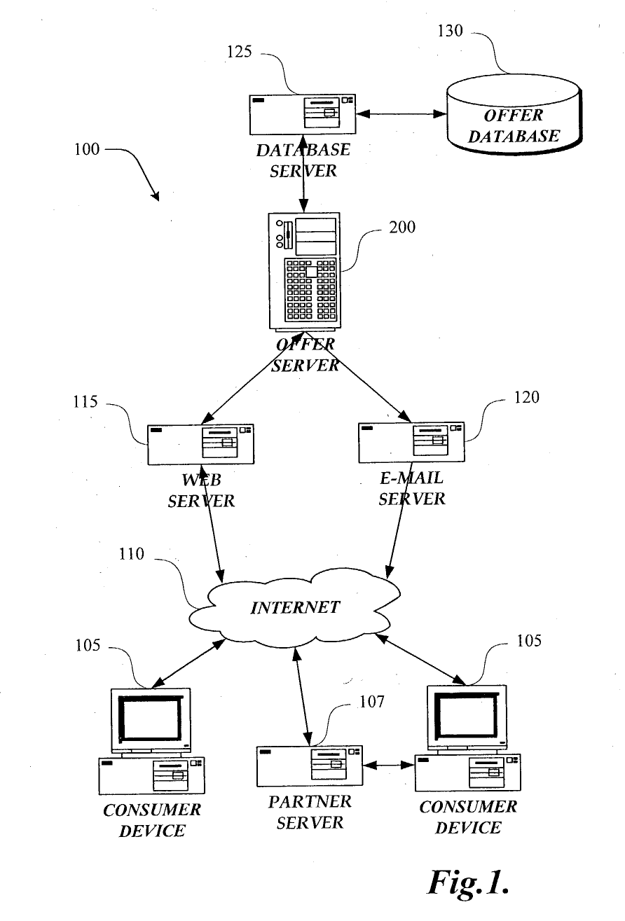

FIG. 1 illustrates a pictorial diagram of a system 100 for placing offers using weighted randomization. The system 100 shown in FIG. 1 includes a Web server 115, an e-mail server 120, a offer server 125, an offer database 130 and an offer server 200, all interconnected over one or more networks. Offers are sent to consumer devices 105 over the internet 110. While the system 100 generally operates in a distributed computing environment comprising individual computer systems interconnected over one or more networks, it will be appreciated by those of ordinary skill in the art and others that the system 100 could equally function as a single standalone computer system, or on more or fewer computer systems than are illustrated in system 100. Thus, the system shown in FIG. 1 should be taken as exemplary, not limiting.

The Web server 115 is responsible for placing offers for consumers depicted at consumer devices 105 via a simplified representation of the Internet 110. Alternatively, the Web server may send offers to a partner server 107, which in turn communicates offers to consumer devices 105. Those of ordinary skill in the art and others will appreciate that the Web server 115 may provide offers for display in a variety of formats. Additionally, those of ordinary skill in the art and others will appreciate that a variety of Web servers 115, or similar devices, may be used by the present invention for sending offers.

The e-mail server 120 is responsible for sending offers out to consumers at consumer devices 105 via a simplified representation of the Internet 110. Those of ordinary skill in the art and others will appreciate that the e-mail server 120 may send “e-mail” offers in a variety of formats. Such formats may include, but by no means are limited to, electronic mail messages, short message services (“SMS”) messages, wireless application protocol (WAP) messages and instant messenger messages. Those of ordinary skill in the art and others will appreciate that a variety of e-mail servers 120, or similar devices, may be used by the present invention for sending offers to consumers.

As noted above, FIG. 1 should be taken as exemplary and not limiting. It will be appreciated by those of ordinary skill in the art and others that the routines and responsibilities of any of the illustrated computing devices in FIG. 1 may be combined with the routines and responsibilities of other servers to reduce the number of computing devices. Additionally, the routines and responsibilities of the illustrated computing devices may be shared with similar devices for parallel processing or may be divided into still more computing devices for a decreased load on any one device.

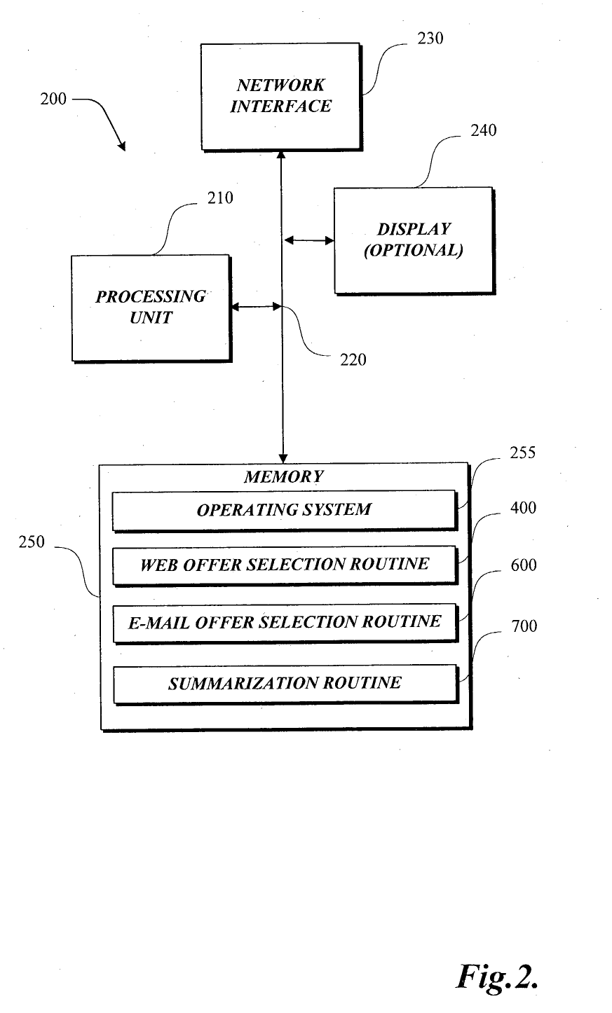

FIG. 2 depicts several of the key components of the offer server 200. Those of ordinary skill in the art will appreciate that the offer server 200 may include many more components than those shown in FIG. 2. However, it is not necessary that all of these generally conventional components be shown in order to disclose an enabling embodiment for practicing the present invention. As shown in FIG. 2, the offer server 200 includes an input/output (“I/O”) network interface 230 for connecting to other devices (not shown). Those of ordinary skill in the art will appreciate that the I/O network interface 230 includes the necessary circuitry for such a connection, and is also constructed for use with the necessary protocols.

The offer server 200 also includes a processing unit 210, an optional display 240, and a memory 250 all interconnected along with the I/O interface 230 via a bus 220. The memory 250 generally comprises a random access memory (“RAM”), a read-only memory (“ROM”), and a permanent mass storage device, such as a disk drive, tape drive, optical drive, floppy disk drive, or combination thereof. The memory 250 stores an operating system 255, a Web offer selection routine 400 for placing offers on a network site, an e-mail offer selection routine 100 for placing offers in direct-to-consumer messages, and a summarization routine 700 for collecting and updating consumer response information. It will be appreciated that these software data components may be loaded from a computer-readable medium into the memory 250 of the offer server 200 using a drive mechanism (not shown) associated with the computer readable medium, such as a floppy, tape or DVD/CD-ROM drive, or via the I/O network interface 230.

Before addressing specific aspects and routines of the present invention illustrated in the drawings, an overview of the invention is described. The present invention optimizes the placement of offers for consumers in an online environment. Offer placements may take many forms, in viewed content (e.g., Web pages, streaming media, and the like) and in delivered content (e.g., e-mails, instant message messages, “push” content, etc.). Each pairing or matching of an offer to a placement (or to a slot in a placement with multiple slots for viewing offers) is assigned a placement value. Offers are generally placed at placements by determining which offer will provide the most revenue (i.e., the offer with the highest placement value.)

A näive implementation of placing offers would always assign the highest valued offer to a particular placement until that offer had been viewed/delivered its maximum number of times. If the same high placement value offer, or same series of offers in the same order, always appears, less valued offers will never have a chance to be seen by consumers. Accordingly, there would not be any chance to measure consumer response to the less valued offers. This failure means that offers that may in fact perform better over time (e.g., have a lower individual revenuem but a better response rate), but to which consumers respond better, do not get an opportunity to reach the consumer.

The present invention introduces the element of indeterminacy by adding (or varying by) random values to the placement values of offers, thereby giving some less valued offers a chance to surpass the placement values of higher valued offers, if consumers respond better to the less valued offers. The responses to these randomized offers are logged and analyzed to better determine the actual placement values of each offer. This randomization works for both viewed content offers (e.g., Web pages) and delivered content offers (e.g., e-mails). By logging consumer responses and periodically updating the effective returns (placement values) it is possible to continually optimize the placements of offers for consumers.

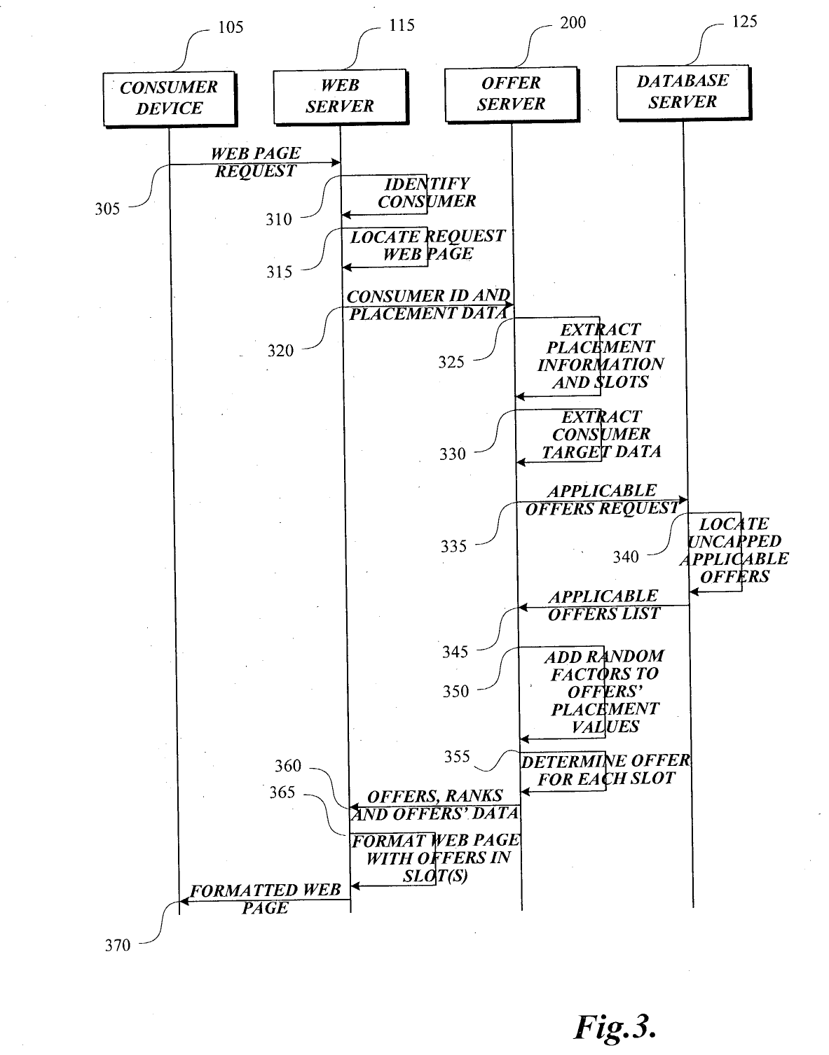

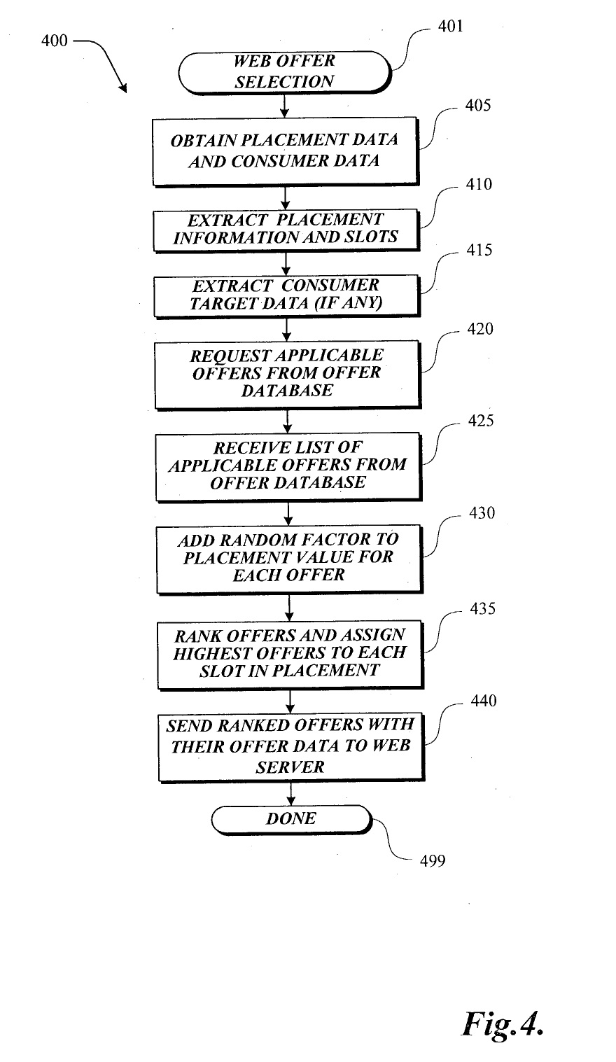

Returning now to the drawings and keeping the overview of the operation of the present invention in mind, FIG. 3 presents an exemplary overview of the operation of the offer placement system 100 of the present invention with respect to viewed content offers. The devices of offer placement system 100 illustrated in FIG. 3 include a consumer device 105, a Web server 115, an offer server 200 and a database server 125. The interactions of, and the routines performed by the various devices are illustrated in FIG. 4 and described below with reference to that figure.

Returning to FIG. 3, an offer placement sequence for a network site is initiated when a consumer device 105 requests 305 a Web page (or site content) from the Web server 115 (or via partner server 107). In response to the request, the Web server 115 retrieves any consumer identity information 310 from the Web page request. Those of ordinary skill in the art and others will appreciate that Web page requests may include identifying information about a consumer and/or the consumer device 105. Next, the Web server 115 locates 315 the requested Web page. The Web page includes offer placement data for the Web page. The consumer's identifying information (if any) and the Web page placement data are forwarded 320 to the offer server 200.

At the offer server 200, the process of matching offers to the received placement data begins. A determination 325 is made from the placement data of what categories (or other information) of offers are eligible for placement and how many slots (spaces for offer to be placed) are available to receive offers. Every placement will have at least one slot for an offer. Next, consumer target data is extracted 330 from any available consumer identifying information. If no consumer identifying information is available, then only the Web page placement data is used for matching offers to the placement. If, however, consumer target data is extractable, then that information is used to better match offers to consumers.

The offer server 200 next requests 335 applicable offers that match the placement categories (or placement information) and any available consumer target data from an offer database 130 at a database server 125. The database server 125 locates 340 any applicable offers that match the placement categories (or placement information) and any available consumer target data. Additionally, the database server 125 may remove, or not consider, offers that have reached their offer cap (i.e., the maximum number of placements available for the offer). Next, the list of applicable offers is forwarded 345 back to the offer server 200. Those of ordinary skill in the art and others will appreciate that if offers that have reached their cap are included in the applicable offer list, then those offers may be excluded at the offer server 200.

The offer server 200 then randomizes 350 the uncapped applicable offers. In one embodiment, the randomization includes adding random factors to offers' placement values 350. Randomization is discussed below with regard to FIG. 4.

Next, the offer server 200 determines 355 which offer shall be routed to each placement slot available for placement at the Web page. In one exemplary embodiment of the present invention, those offers with the highest randomized placement values are ranked such that each offer is placed in a slot according to its rank among the other offers. The offers' ranks and the offers' data are then sent 360 to the Web server 115. The Web server 115 formats 365 a Web page with the returned offers in their placement slot (or slots). The formatted Web page is then returned 370 to the consumer device 105 for depiction to a consumer.

As will be appreciated by those of ordinary skill in the art, FIG. 3 represents one exemplary set of interactions between the devices of system 100. As also will be appreciated by those of ordinary skill in the art, additional interactions and selections may be involved in other sets of interactions between the devices of system 100. Additionally, it will be appreciated by those of ordinary skill in the art and others that the actions illustrated in FIG. 3 may be performed in other orders or may be combined. For example, randomizing offers and determining the placement of offers in slots may be performed as a weighted random ranking of offers that have been returned from the database server 125.

As illustrated in FIGS. 1, 2 and 3, the embodiment of the offer placement system 100 described herein includes an offer server 200 that is used to place viewed content offers for presentation on a network site to consumers on a consumer device 105. A flow chart illustrating an offer selection routine 400 implemented by the offer server 200, in accordance with an exemplary embodiment of the present invention described herein, is shown in FIG. 4.

Web offer selection routine 400 begins at block 401 and proceeds to block 405 where the offer server 200 obtains placement data and consumer data. Those of ordinary skill in the art and others will appreciate that in a Web page request the placement data and consumer data may be conveyed to an offer server executing the Web offer selection routine 400. Next, at block 410, a placement category or categories (or other placement information) is extracted from the placement data. Placement categories (or placement information) may be any designation of which types of offers would be applicable for placement at the Web pages' placement. One of ordinary skill in the art and others will appreciate that placement information may include subject categories (e.g., sports, shopping, books, electronics, services, etc.), as well as the form that the offer takes (e.g., a coupon, sale notice, specific price, new product notification, clearance notification, a night time only offer, etc.). Additionally, in block 410, the number of available slots (for placing offers) is extracted from the placement data. It will of course be appreciated by those of ordinary skill in the art that a Web page may have multiple placements with each placement having multiple slots. However, for purposes of discussion, a Web page with a single placement will be used to describe the operation of routine 400. Next in block 415, any available consumer target data is extracted from the consumer data obtained in block 405. Those of ordinary skill in the art and others will appreciate that a myriad of sources of consumer data may be available to routine 400. In one exemplary embodiment of the present invention, the responses of individual consumers are tracked such that if a consumer responded positively to an offer in the past, then that information may be used to target offers to the consumer in the future (e.g., by using similar category data).

In block 420 applicable offers are requested from an offer database 130. Applicable offers are those offers that correspond in some way to the information (e.g., categories and the like) extracted for the placement as well as any consumer target data extracted in block 415. In block 425, the offer database 130 returns a list of applicable offers that match the information provided. Each of these offers received from the offer database 130 has a placement value associated with it. In one embodiment of the present invention where offer placement values are grouped per thousand offer placements, the placement value is referred to as the effective cost per thousand (“ECPM”) of the offer. The placement value generally corresponds to the expected revenue for placing a predetermined number of offers at a particular placement. For example, if an offer had an ECPM (which measures per thousand offer placements) of ten dollars, then that means that there is an expected revenue of ten dollars for placing that offer at that particular placement one thousand times.

As noted above, the placing of offers at particular placements includes an element of indeterminacy. In one embodiment, the indeterminate element is introduced by adding a random factor to each placement value of the returned offers. Accordingly, in block 430, the random factor is added to the placement value for each offer retrieved from the offer database 130. The range that the random factor uses to determine how much to add to each placement value may vary depending on how much deference is to be given to offers with high placement values. In one embodiment, the range of the random factor is from zero to the highest placement value of the returned offers. In certain other embodiments of the present invention, the range may be further modified depending on the number of slots available to a particular placement. For example, if there are ten possible offers and only a single slot for placement, the upper end of the range of the random factor to be added is increased. This increase in range allows less valued offers to still have a chance at being placed when fewer slots are available.

Therefore, in a simple example with three offers, where one offer has a placement value of ten, one offer has a placement value of five, and one offer has a placement value of one, even if a random value of between zero and the highest placement value (i.e., ten) were added to each of the offer values, the offer with the placement value of one may still have only a small chance of ever exceeding the offer with a placement value of ten because the weight of a placement value of ten is so high relative to a placement value of one. Therefore, in one alternate embodiment of the present invention, the range for which random factors are added to offers varies inversely with the number of slots available in a placement. Those of ordinary skill in the art and others will appreciate that with two slots available in a placement with the above example, the offer with the placement value of one still has a significant chance of being placed, as it is competing with the offer with a value of five as well.

Returning to routine 400, processing continues to block 435, where the offers are ranked by their randomized placement values and assigned to each slot in order in the placement. Next, in block 440, the ranked offers and their offer data are sent to the Web server 115 for eventual depiction at a consumer computer 105. Routine 400 then ends at block 499.

Those of ordinary skill in the art and others will appreciate that other forms of randomizing offers may be used other than adding random factors to placement values of offers, as described above. For example, in one exemplary alternate embodiment, offers may be randomized according to a weighted sorting routine such that offers are only likely to get placed if a randomly generated number in the range of zero to the highest placement value is below their respective placement values.

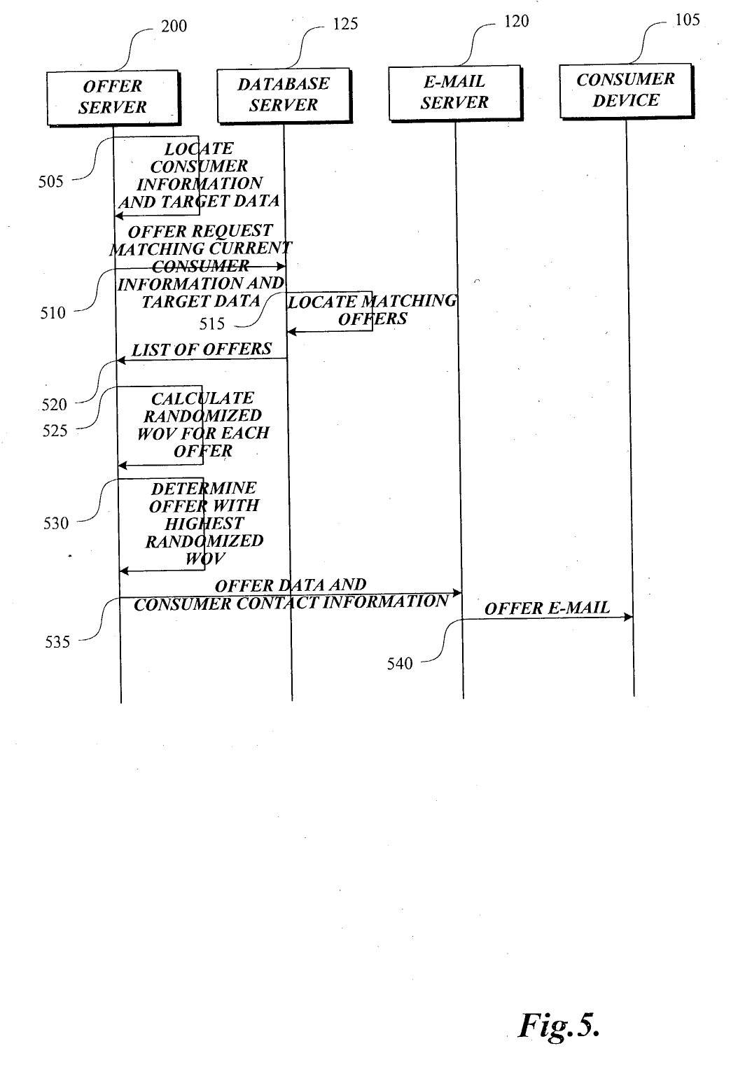

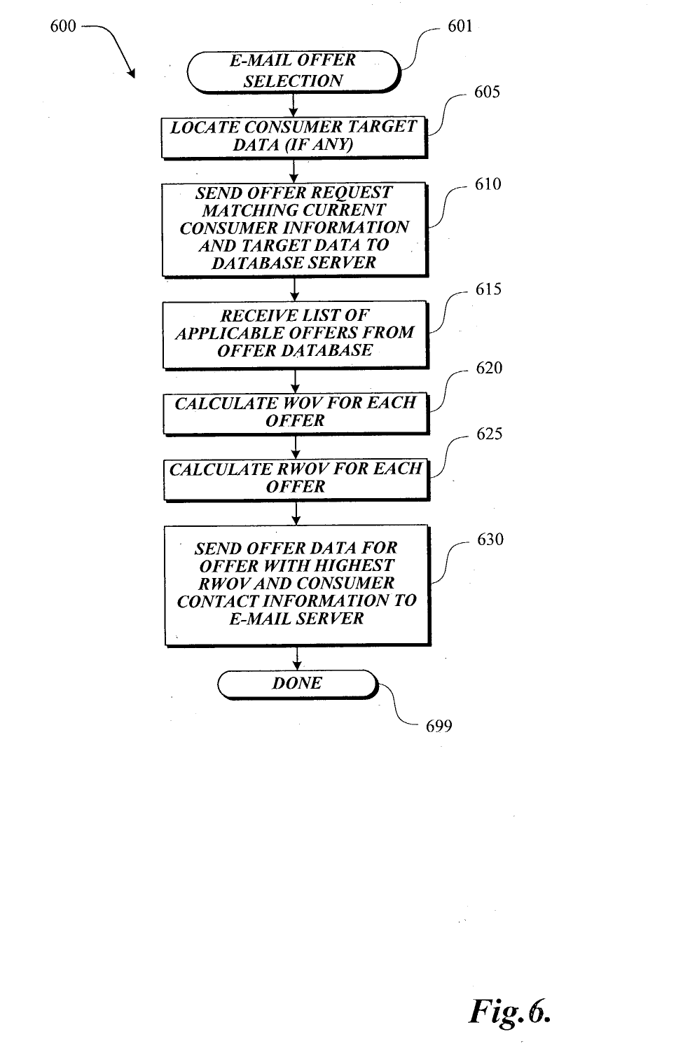

Similarly to FIG. 3 described above, FIG. 5 presents an overview of the operation of the offer placement system 100 of the present invention for placing delivered content (e.g., offers in e-mails) to consumers. FIG. 5 illustrates an exemplary sequence of interactions between the devices of the offer placement system 100, shown in FIG. 1. The devices of the offer placement system 100 illustrated in FIG. 5 include an offer server 200, a database server 125, an e-mail server 120, and a consumer device 105. The interactions of, and the routines performed by, the various devices are illustrated in FIG. 6 and described below with reference to that figure.

An offer placement sequence for a delivered content offer is initiated when an offer server 200 locates 505 consumer information and target data for a particular consumer. For example, the consumer information could include those categories of offers that are applicable to that consumer. Consumer target data may include consumer information such as their age, gender, income level, and other demographic information. The offer server 200 then sends an offer request 510 to a database server 125 for offers that match the current consumer's information and target data. The database server 125 locates matching offers 515 that correspond with the consumer's categories and target data. The database server 125 then returns 520 the list of matching offers. Next, the offer server 200 calculates a randomized weighted offer value (“RWOV”) for each offer in the list. The RWOV is calculated in one embodiment by adding a randomized factor to a weighted offer value (“WOV”) of each offer in the list. Calculating the WOV and RWOV is described below with regard to FIG. 6. The offer server 200 next determines which offer has the highest RWOV. The offer data for the offer with the highest RWOV and the consumer's contact information are forwarded 535 to the e-mail server 120. The e-mail server 120 then sends out an offer e-mail 540 to the consumer device 105 that includes the offer with the highest RWOV.

As will be appreciated by those of ordinary skill in the art, FIG. 5 represents one exemplary set of interactions between the devices of the offer placement system 100. As also will be appreciated by those of ordinary skill in the art, additional interactions and selections may be involved in other sets of interactions between the devices of offer placement system 100. Additionally, it will be appreciated by those of ordinary skill in the art and others that the actions illustrated in FIG. 5 may be performed in other orders or may be combined. For example, the offer server 200 and database server 125 may actually perform their actions on the same device and accordingly the sending and returning of offers between devices would not be necessary.

As illustrated in FIGS. 1, 2 and 5, the embodiment of the offer placement system 100 described herein includes an offer server 200 that is used to place offers for delivery to consumers on a client device 105. A flowchart illustrating an offer selection routine 600 implemented by the offer server 200, in accordance with an exemplary embodiment of the present invention described herein, is shown in FIG. 6.

E-mail offer selection routine 600 begins at block 601 and proceeds to block 605, where consumer target data and categories are located for a particular consumer. In one exemplary embodiment of the present invention the consumer target data and categories are periodically retrieved from the database server 125, however those of ordinary skill in the art and others will appreciate that the offer server 200 may maintain this information itself.

In block 610, an offer request matching the current consumer's category or categories and any available target data is sent to the database server 125. In block 615, the list of applicable offers from the offer database server 125 is received. Each of the offers in the received list of offers has a WOV. The WOV is calculated taking into account an offer's placement value as well as consumers' responses to offers in the past. In one exemplary embodiment of the present invention, the WOV is calculated as defined below:

WOV=(C+(C(ORV)*X1)+(C*(OCt/SOCt)*X2)+(C*(CICt/SOCt)*X3)+(C*(OpCt/SOCt)*X4)

C=Current Placement Value (ECPM) for the offer.

ORV=Offer Relationship Value. If it is known that there is correlation between two offers then there should exist a value defining the percentage of likelihood for buying the correlated offer. As an example, if we know through past experience that people who were sent a soap offer were 10% likely to also buy perfume then an ORV would be defined with a value of 0.1 between those two offers.

SOCt=Sent Offer Count. Number of offers with corresponding categories that have been sent out to a consumer having matching categories of the current offer.

OCt=Category Order Count. Number of times consumer participated in an offer that is in the same category as the current offer.

ClCt=Category Click Count. Number of times consumer clicked on an offer in the same category as current offer.

OpCt=Category Open Count. Number of times consumer opened an offer in the same category as current offer.

X1—Offer relationship weight (e.g., 0.900)

X2—Offer order weight (e.g., 0.500)

X3—Offer click weight (e.g., 0.250)

X4—Offer open weight (e.g., 0.100)

Those of ordinary skill in the art and others will appreciate that the above definition of a WOV is only an exemplary implementation and that other methods of valuing offers may be used without departing from the spirit and scope of the present invention. For example, some offers may be weighted with more value during different times of the day.

Processing in routine 600 then proceeds to block 625 where a RWOV is calculated for each offer. In one exemplary embodiment of the present invention, the RWOV is calculated by adding a random number between zero and the maximum WOV of the received offers to each of the offers' WOVs. In block 630, routine 600 then sends the offer data corresponding to the offer with the highest RWOV and consumer contact information to an e-mail server to then be sent out to a consumer as an e-mailed offer. Routine 600 then ends at block 699.

Those of ordinary skill in the art and other will appreciate that other method of selecting deliver offer may be used without departing from the spirit and scope of the present invention. For example, in one alternate embodiment of the present invention, offers may include other offer instances of each offer. Offer instances are variations of the same offer. Accordingly, two offer instances may have different formats or styles for presenting the same offer. Therefore, after the offer with the highest RWOV is determined, a randomized weighted offer instance value (“RWOIV”) is calculated. The weighted offer instance value (“WOIV”) is defined in one exemplary embodiment as:

WOIV=(C*(OCt/SOCt)*X2)+(C*(CICt/SOCt)*X3)+(C*(OpCt/SOCt)*X4)

The RWOIV is then calculated in a similar manner as the RWOVs described above in that a random factor of between zero and the highest WOIV is applied to each of the WOIVs to determine an offer instance with the highest RWOIV. Accordingly, the offer instance with the highest RWOIV would be the offer instance that is sent to the email server for delivery to a consumer as an e-mailed offer.

Those of ordinary skill in the art and others will appreciate that viewed offers may also include offer instances and that randomizing placements of offer instances would proceed in an analogous manner.

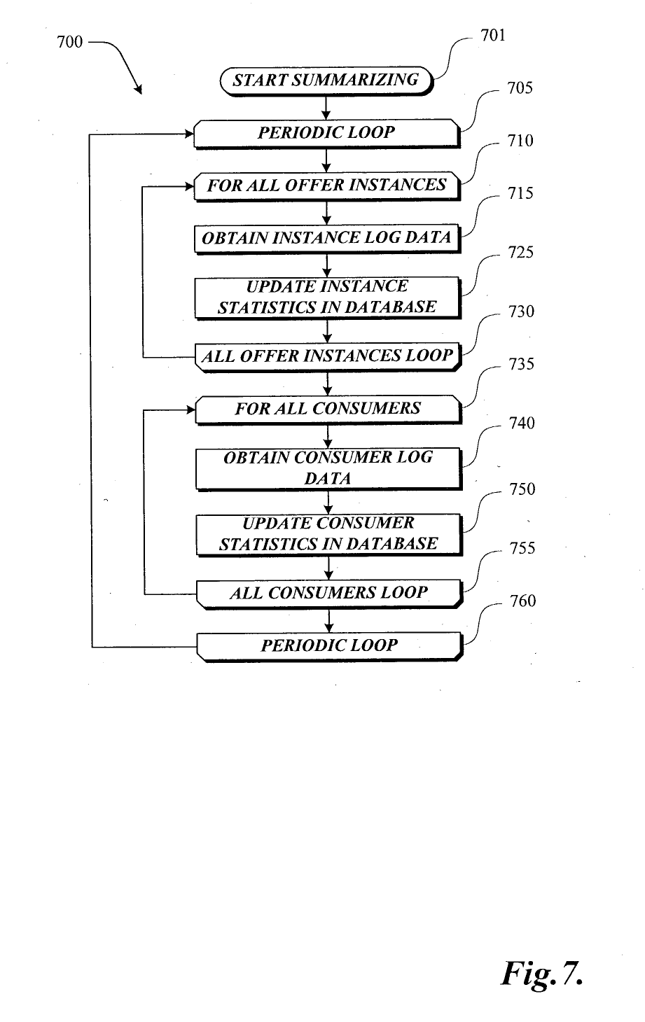

In order for the randomization and weighting of offer placements to be effective, information about the revenue generated by offers and consumer responses to offers is useful (e.g., to determine the placement values of offers). Accordingly, FIG. 7 illustrates an exemplary information summarization routine 700 for summarizing both offer and consumer log data and statistics (e.g., placements values, offers seen, clicked, opened, ordered from, etc.). By continually summarizing offer and consumer data, placement values and WOVs remain current. Summarization routine 700 begins at block 701 and proceeds to looping block 705 where a periodic loop begins. The periodic loop may be set for any period of time that is appropriate for gathering summaries of information about consumer responses and offer performance. In one exemplary embodiment, the period may range from between one minute to 24 hours. However, those of ordinary skill in the art will appreciate that other ranges may be used without departing from the spirit and scope of the present invention.

Routine 700 then continues to looping block 710, where an iteration through each offer instance begins. Next, at block 715 offer instance log data is obtained from a log that offers performance. Processing proceeds to block 725 where the verified log data is used to update the statistics (including the offer instances placement values for the placements with further log information). Processing then continues to loopback block 730 and cycles back to looping block 710. After all offer instances have been iterated through, processing proceeds from loopback block 730 to looping block 735.

At looping block 735, an iteration through each consumer begins. Next, at block 740, consumer log data is obtained corresponding to consumer responses to placed offers. In block 750, the consumer statistics are updated in the database 130. Processing then proceeds to loopback block 755 which cycles back to looping block 735. After all consumers have been iterated through, processing proceeds from loopback block 755 to loopback block 760 which cycles back to looping block 705.

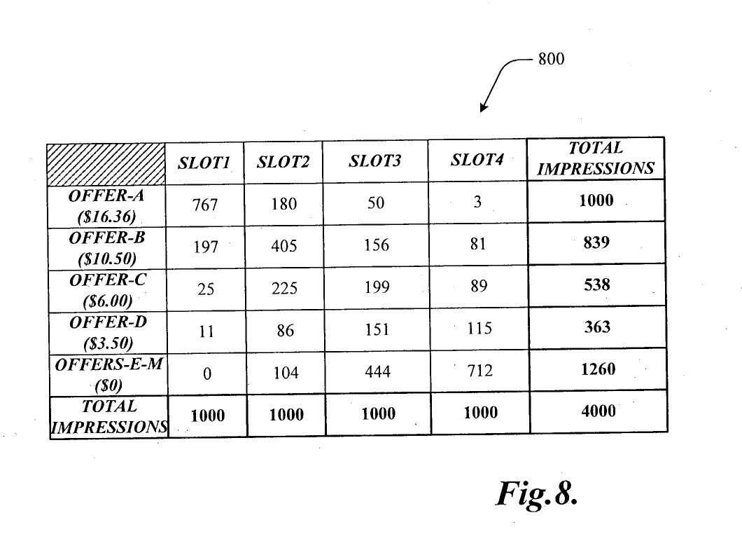

Now that the operation of the offer placement system has been described, two specific examples of offer placement will be described. A first exemplary scenario for a viewed content placement, e.g., a Web page having a single placement with four slots, is illustrated in FIG. 8. The applicable offers (Offers A-M) each have an associated placement value (e.g., Offer A has a placement value of $16.36, Offer B has a placement value of $10.50, etc.). Table 800 shows the placement of offers in each slot of the placement utilizing a randomized placement value system in accordance with the present invention over a thousand repeated impressions. Accordingly, we can see that Offer A in the highest slot, slot 1, was placed 767 times. However, Offer A was only placed three times in slot 4. Additionally, we can see that Offers E-M which all have a placement value of $0, never achieved a placement in Slot 1, however, they were placed a number of times in Slots 2-4.

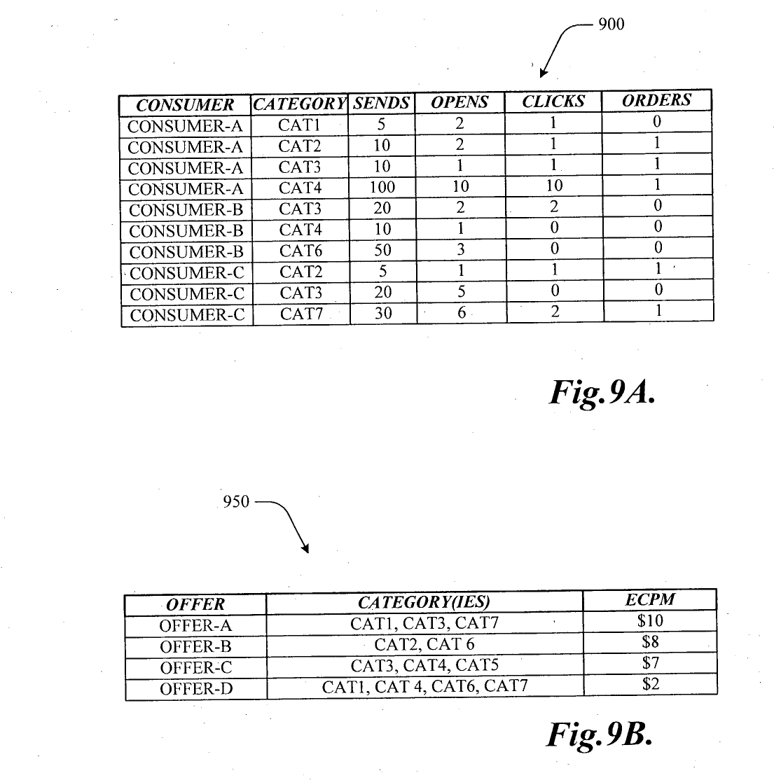

A second scenario is illustrated with regard to FIGS. 9A-B used in association with a delivered content placement. In particular, FIGS. 9A-B provide exemplary tables to be used in calculating an illustrative WOV.

WOV=(C+(C*(ORV)*X1)+(C*(OCt/SOCt)*X2)+(C*(CICt/SOCt)*X3)+(C*(OpCt/SOCt)*X4))

WOV for Offer A:

C (Offer-A)=$10

ORV=0%

SOCt=(10+5)=15

OCt=(0+1)=1

CICt=(1+1)=2

OpCt=(2+1)=3

X1=0.9, X2=0.5, X3=0.25, X4=0.1

WOV=(10+(10*(0)*0.9)+(10*(1/15)*0.5)+(10*(2/15)*0.25)+(10*(3/15)*0.1))=WOV=10.86667=$10.87

WOV for Offer B:

C (Offer-B)=$8

ORV=10%=0.1

SOCt=10

OCt=1

CiCt 1

OpCt=2

X1=0.9,X2=0.5,X3=0.25, X4=0.1

WOV=(8+(8*(0.1)*0.9)+(8*(1/10)*0.5)+(8*(1/10)*0.25)+(8*(2/10)*0.1))=WOV=9.48=$9.48

An additional explanation of the values used when calculating the WOV is aided by the above formulas and tables 900 and 950. In particular, supposing a Consumer A is being matched with a set of applicable offers. Then suppose that Offers C and D are eliminated due to incompatible consumer target data (e.g., the offers were for men and Consumer A is a woman). The remaining offers are Offers A and B. Accordingly, WOVs are calculated for Offers A and B with regard to Consumer A. The SOCt for offer A is calculated by viewing the categories of Offer A that match with the categories of Consumer A (i.e., CAT1 and CAT3, but not CAT7) and tabulating the total “sends” in table 900. In table 900 we can see that consumer A has been sent five category CATI offers and ten CAT3 offers. Accordingly, the SOCt of offer B with regard to Consumer A is calculated by adding all these values together to reach a value of fifteen. The OCt count is derived from calculating how many orders were placed in the categories that match between Offer A and the Consumer A. Accordingly, there was one order from Consumer A in category CAT3 and none in CATI. Accordingly, the order count (OCt) is one. The same process is repeated with the click count (ClCt) and the open count (OpCt). Once all these variable pieces of information have been retrieved then a WOV can be calculated for a particular offer and consumer. The process would then be repeated for Offer B as well.

Those of ordinary skill in the art and others will appreciate that the above example is merely presented for illustrative purposes and that other values, in particular the values for weights X1-4, may be used depending on the weight given to orders, clicks, opens and offer relation values (ORVs).

Next RWOVs would be calculated. The highest placement value is $10.00 for Offer A. Accordingly, in one embodiment, a random value between 0 and 10 is added to the WOVs calculated above. Assuming random values of 4.5 and 8.2 are generated for each offer respectively. The RWOV for Offer A would be $10.87+$4.50=$15.37; and the RWOV for Offer B would be $9.48+$8.20=$17.68. These RWOVs are then compared and the offer with the highest RWOV, in this example Offer B, is placed for delivery to the consumer.

While an exemplary embodiment of the invention has been illustrated and described, it will be appreciated that various changes can be made therein without departing from the spirit and scope of the invention as defined by the appended claims.

The embodiments of the invention in which an exclusive property or privilege is claimed are defined as follows:

1. A computer implemented method of placing an offer on a network accessible site, the method comprising:
obtaining placement data for an offer placement, including placement information;
obtaining a plurality of offers using said placement data, each having offer information corresponding to said placement information and a placement value for said offer placement;
randomizing placement values by varying each of said offers' placement values by a random factor; and
placing the offer with the highest randomized placement value on network accessible site.

2. The method of claim 1, wherein said offer placement includes a plurality of slots, each slot for an offer.

3. The method of claim 2, wherein said random factor is added to each of said offers' placement values and increases in inverse relation to the number of said slots.

4. The method of claim 2, wherein said offers are placed in said slots in the order of their randomized placement values.

5. The method of claim 1, further comprising determining a highest placement value of said placement values.

6. The method of claim 5, wherein said random factors are within the range of substantially zero to substantially said highest placement value.

7. The method of claim 5, wherein said random factors are within the range of substantially zero to a value more than said highest placement value.

8. The method of claim 1, wherein said placement data further includes consumer target data.

9. A computer readable medium, containing computer executable instructions for performing the method of any of claims 1-8.

10. A computing apparatus including a processor and a memory having computer executable instructions, and operative to execute the computer executable instructions with said processor to perform the method of any of claims 1-8.

11. A computer implemented method of sending an offer to a consumer over a network, the method comprising:
obtaining a plurality of offers, each offer having offer information corresponding to one or some consumer information;
calculating a weighted offer value for each of said offers;
randomizing weighted offer values by varying each weighted offer value by a random factor; and
sending the offer with the highest randomized weighted offer value to the consumer.

12. The method of claim 11, wherein said offers are obtained using consumer target data.

13. The method of claim 11, wherein said offers are obtained from a remote database.

14. The method of claim 11, wherein said weighted offer value is calculated based on the number of offer opens.

15. The method of claim 11, wherein said weighted offer value is calculated based on the number of offer clicks.

16. The method of claim 11, wherein said weighted offer value is calculated based on the number of offer orders.

17. The method of claim 11, wherein said weighted offer value is calculated based on any added value from a related offer.

18. The method of claim 11, wherein said weighted offer value is calculated based on a time of placement.

19. The method of claim 5, wherein said offers further comprise placement values and said random factors are substantially within the range of zero to a highest placement value.

20. The method of claim 5, wherein said offers further comprise placement values and said random factors are substantially within the range of zero to a value more than a highest placement value.

21. A computer readable medium, containing computer executable instructions for performing the method of any of claims 11-20.

22. A computing apparatus including a processor and a memory having computer executable instructions, and operative to execute the computer executable instructions with said processor to perform the method of any of claims 11-20.

23. A computer implemented method of placing an offer for receipt by a consumer, the method comprising:
obtaining data for placing the offer, including placement information;
obtaining a plurality of offers using said data, each having offer information corresponding to said placement information and a placement value for placing each offer;
adjusting the placement of said offers by varying said placement value of each of said offers by an indeterminate amount; and
placing an offer selected from the others with varied placement values.

24. The method of claim 23, wherein the offer is a viewed offer.

25. The method of claim 23, wherein the offer is a delivered offer.

26. The method of claim 23, wherein placement value is periodically updated.
